(19) United States
(12) Patent Application Publication
(10) Pub. No.: US 2007/0236817 A1
(43) Pub. Date: Oct. 11, 2007

(54) Magnetic-tape recording method, magnetic-tape recording apparatus, and computer system

(75) Inventor: Hiroaki Taruisi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/471,844

(22) Filed: Jun. 21, 2006

(30) Foreign Application Priority Data
Mar. 27, 2006 (JP) 2006-086348

(51) Int. Cl. G11B 5/02

(52) U.S. Cl. 360/18

(57) ABSTRACT

A control-dataset storage controller controls storing a control dataset of a file to be recorded on a track unit that is identified by the track-unit identification data, in association with the track-unit identification data, in a control-dataset storing unit. A track-unit specification controller controls specifying a track unit for recording a specified file, based on the stored control dataset. A file recording controller controls recording the specified file on the specified track unit.

### BACKGROUND OF THE INVENTION

1. Field of the Invention

The present invention relates to a technology for performing a round-trip recording of a single file on a plurality of tracks forming a track unit of a magnetic tape.

2. Description of the Related Art

Conventionally, a magnetic tape volume is used as a backup medium of data that is recorded in a recording device included in a computer system. Even with the spread of recording media such as a magnetic disk device or a magneto optical disk, the magnetic tape volume is still significant as the backup medium.

The magnetic tape volume houses a magnetic tape by reeling in two reels, and by rotating the two reels changes a tape winding amount of both the reels, thereby moving a position of a read/write magnetic head with respect to the magnetic tape and sequentially recording data. The aforementioned sequential file recording method is commonly used.

Recently, the magnetic tape is divided into a large number of tracks and used, thereby rapidly enhancing a recording density of the magnetic tape itself. Under such circumstances, for reading and writing of the file using the sequential file recording method, a process to search a file position of the required file and to position the read/write magnetic head at the necessary recording position is time consuming.

A conventional technology for the magnetic-tape recording is disclosed in, for example, Japanese Patent Laid-Open Publication No H2-122489 and Japanese Patent Laid-Open Publication No H11-164241.

However, according to the conventional technology, because a single round-trip track or multiple tracks on the magnetic tape are virtually linked and treated as a single volume and two files are recorded serially, when carrying out overwriting or addition of data to the multiple files that are saved in the magnetic tape volume, data in the head of the subsequent file is destroyed during overwriting or addition of data.

To avoid destruction of data in the head of the subsequent file, data for carrying out overwriting or addition must be positioned at the end of all the files. Due to this, the same file is split into other files, thereby significantly reducing the process efficiency of file access.

In addition, if a long magnetic tape divided into multiple tracks is used, a physical head of the magnetic tape does not match with the head of the file when accessing the file, thereby resulting in a longer time period for a file detecting process.

### SUMMARY OF THE INVENTION

It is an object of the present invention to at least partially solve the problems in the conventional technology.

A method according to one aspect of the present invention is for setting a plurality of tracks as a track unit on a magnetic tape, allocating track-unit identification data to the track unit, and performing a round-trip recording of a single file on the tracks forming the track unit. The method includes storing a control dataset of a file to be recorded on a track unit that is identified by the track-unit identification data, in association with the track-unit identification data; specifying a track unit for recording a specified file, based on the stored control dataset; and recording the specified file on the specified track unit.

A magnetic-tape recording apparatus according to another aspect of the present invention records a file on a magnetic tape based on a file recording instruction from a computer to which the magnetic-tape recording apparatus is connected. The magnetic-tape recording apparatus sets a plurality of tracks as a track unit on the magnetic tape, allocates track-unit identification data to the track unit, and performs a round-trip recording of a single file on the tracks forming the track unit. The magnetic-tape recording apparatus includes a control-dataset input/output unit that performs input and output of the track-unit identification data and a control dataset of the file corresponding to the track-unit identification data, in response to an instruction from the computer; a position determining unit that determines a recording position of the file on the magnetic tape based on the track-unit identification data and the control dataset; and a file-data input/output unit that reads or records data of the file at the recording position determined by the position determining unit.

A magnetic tape unit according to still another aspect of the present invention is capable of setting a plurality of tracks as a track unit on a magnetic tape, allocating track-unit identification data to the track unit, and performing a round-trip recording of a single file on the tracks forming the track unit. The magnetic tape unit includes a control-dataset storing unit that stores a control dataset of a file to be recorded on a track unit that is identified by the track-unit identification data, in association with the track-unit identification data.

A computer system according to still another aspect of the present invention is configured to be connected to a magnetic-tape recording apparatus that sets a plurality of tracks as a track unit on a magnetic tape, allocates track-unit identification data to the track unit, and performs a round-trip recording of a single file on the tracks forming the track unit. The magnetic tape is installed in a magnetic tape unit including a control-dataset storing unit. The computer system includes a control-dataset storage controller that controls storing a control dataset of a file to be recorded on a track unit that is identified by the track-unit identification data, in association with the track-unit identification data, in the control-dataset storing unit; a track-unit specification controller that controls specifying a track unit for recording a specified file, based on the stored control dataset; and a file recording controller that controls recording the specified file on the specified track unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating features and drawbacks of a conventional magnetic-tape recording method;

FIG. 2 is a schematic for illustrating features of a magnetic-tape recording method according to an embodiment of the present invention;

FIG. 3 is a schematic for illustrating features of the magnetic-tape recording method according to the present embodiment when a single file extends to multiple tracks;

FIG. 4 is a block diagram of a magnetic-tape recording apparatus according to the present embodiment; and

FIG. 5 is a flowchart of a sequence of a magnetic-tape recording process according to the present embodiment.

### DETAILED DESCRIPTION OF THE PREFERRED EMBODIMENTS

Exemplary embodiments of the present invention are explained in detail below with reference to the accompanying drawings. In the following embodiments, the present invention is applied to a magnetic-tape recording apparatus that is connected to a mainframe computer that is used as a host computer in batch processing. However, the present invention can also be applied to the magnetic-tape recording apparatus that is connected to a server or a personal computer (PC). Furthermore, although a magnetic tape confirming to digital linear tape (DLT) standard is used in the following embodiments, a magnetic tape confirming to quarter-inch cartridge Drive Standards (QIC), digital audio tape (DAT) standard or digital data storage (DDS) standard can also be used.

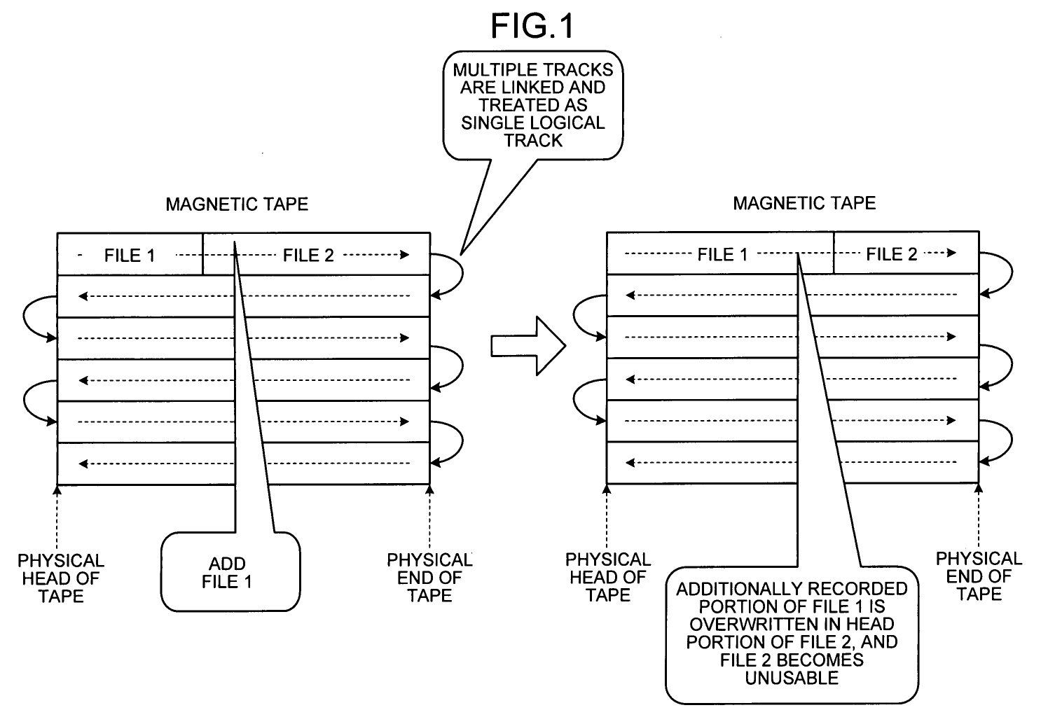

FIG. 1 is a schematic for illustrating features and drawbacks of a conventional magnetic-tape recording method. As shown in FIG. 1, in the conventional magnetic-tape recording method, data is recorded in a track in a predetermined direction from the physical head of the magnetic tape. Upon reaching the end of the track due to reaching the physical end of the magnetic tape, the physical end of the magnetic tape in a next track positioned immediately below is treated as a head of the track, and data is recorded in a reverse direction of the predetermined direction. Upon reaching the end of the next track due to reaching the physical head of the magnetic tape, the physical head of the magnetic tape in a subsequent track positioned further immediately below is treated as the head of the subsequent track, and data is recorded in the predetermined direction.

Thus, in the conventional magnetic-tape recording method, end points of adjacent tracks at the physical head of the magnetic tape and the physical end of the magnetic tape are virtually linked and the multiple tracks are treated as if a single track, thereby recording data while moving back and forth on the magnetic tape.

Because the conventional magnetic-tape recording method uses a single virtual track, when recording multiple files in the single virtual track, generally the next file is recorded subsequently after the end of a file.

However, when another file is subsequently recorded at the end of a file, considering the nature of access to the file, if addition of data is carried out while maintaining the continuity of file position, overwriting is carried out by destroying the head of the other subsequent file, and use of the subsequent file is disabled.

As shown in FIG. 1, “file 2” is recorded subsequently after “file 1”. And then, when data is added to “file 1”, a head of “file 2” is overwritten by additional data of “file 1”. Especially, a dataset that is necessary for file control is included in the head of a file. Thus, due to destruction of the control dataset, use of “file 2” is completely disabled.

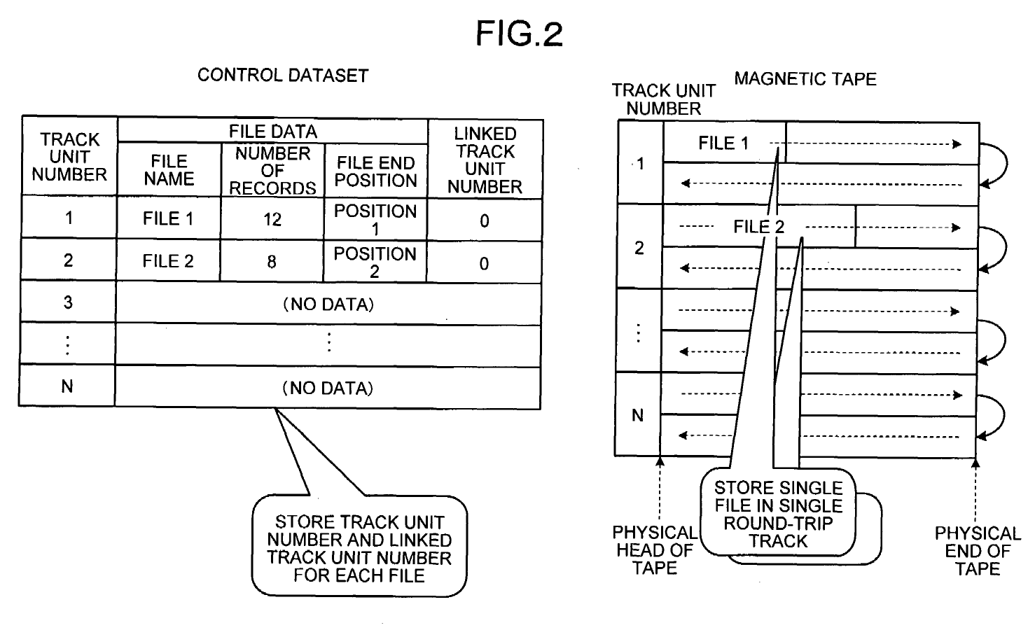

FIG. 2 is a schematic for illustrating features of a magnetic-tape recording method according to an embodiment of the present invention. As shown in FIG. 2, the magnetic-tape recording method according to the present embodiment is realized by a combination of the control dataset and the magnetic tape.

The magnetic tape treats upper and lower multiple tracks as track units. The track units are allocated track unit numbers from 1 to N. Among the tracks included in a track unit, data is recorded in a direction from the physical head of the magnetic tape to the physical end of the magnetic tape in the upper track. A head of the upper track matches with the physical head of the magnetic tape, and an end of the upper track matches with the physical end of the magnetic tape.

Data is recorded in a direction from the physical end of the magnetic tape to the physical head of the magnetic tape in the lower track. A head of the lower track matches with the physical end of the magnetic tape, and an end of the lower track matches with the physical head of the magnetic tape. The end of the upper track and the head of the lower track are virtually linked, thus the two tracks on the upper and the lower sides are treated as a single track. Such a track of a single round trip is called the track unit. Each track unit is allocated a track unit number. A single file is recorded in a single track unit from the head of the track.

For example, as shown in FIG. 2, “file 1” is recorded in the track unit having the track unit number “1”. Similarly, “file 2” is recorded in the track unit having the track unit number “2”.

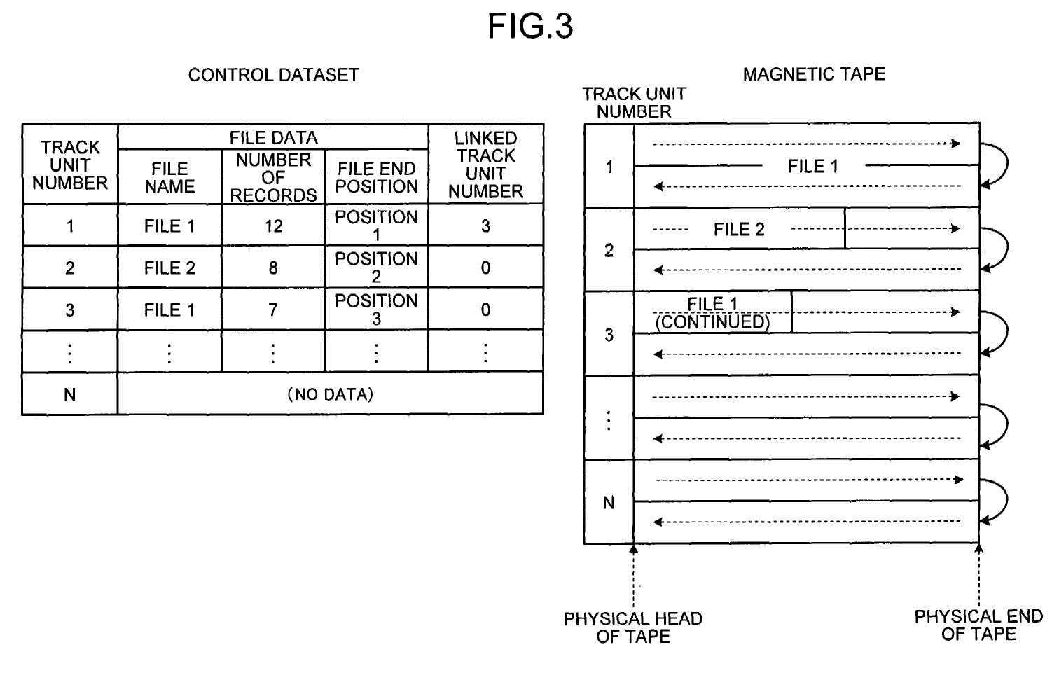

A relation between the track unit number and file attributes data such as a file name etc. that is recorded in the track unit number is recorded in the control dataset. The control dataset maintains data in a predetermined table format. As shown in FIG. 2, a table of the control dataset includes columns of “track unit number”, “file data” (file name, number of records, file end position etc.), and “linked track-unit number”. “Linked track-unit number” is explained later with reference to FIG. 3.

A correspondence between the “track unit number” and the “file data” that are stored in the table of the control dataset enables to determine the file that is recorded in the track unit and includes the file attributes (file name, number of records, file end position etc.). “Number of records” indicates a number of data that are stored in the file due to repeated structure of data. “File end position” is data that indicates magnetic tape position inside the track unit corresponding to the end position of the file.

Thus, storing only a single file in a single track unit enables to add data to the file without destroying another file. Further, a storage position of the file is determined from the “track unit number”, thereby enabling to speedily carry out a file accessing process. Even after specifying the track unit that includes the required recorded file using the “track unit number”, because the head of the file matches with the head of the track unit, the file accessing process can be speedily carried out even when accessing each file randomly.

FIG. 3 is a schematic for illustrating features of the magnetic-tape recording method according to the present embodiment when a single file extends to multiple tracks. As shown in FIG. 3, a single file is recorded in a single track unit, and if unrecorded data exists even after reaching the end of the track unit, a track unit in the uppermost position is searched among the blank track units that do not include a recorded file, and data is subsequently recorded in the blank track unit in the uppermost position.

For example, as shown in FIG. 3, data of “file 1” is recorded in the track unit having the track unit number “1”. If unrecorded data of “file 1” exists even after reaching the end of the track unit, because “file 2” is already recorded in the track unit having the track unit number “2” but a file is not yet recorded in the track unit having the track unit number “3”, the track unit having the track unit number “3” is searched as the blank track unit in the uppermost position that does not include a recorded file.

The unrecorded data of “file 1” is subsequently recorded in the track unit having the track unit number “3”, and “3” is stored in the “linked track-unit number” column in the record of the track unit number “1” in the table of the control dataset. Thus, subsequent recording of the file in the track unit is controlled.

Therefore, in the magnetic-tape recording method, only a single file is stored in a single track unit, and even if the file is not completely accommodated in a single track unit, another track unit is virtually linked by specifying a “linked track-unit number”, thereby enabling to add data without destroying another file even when data of the file is added to more than a single track unit.

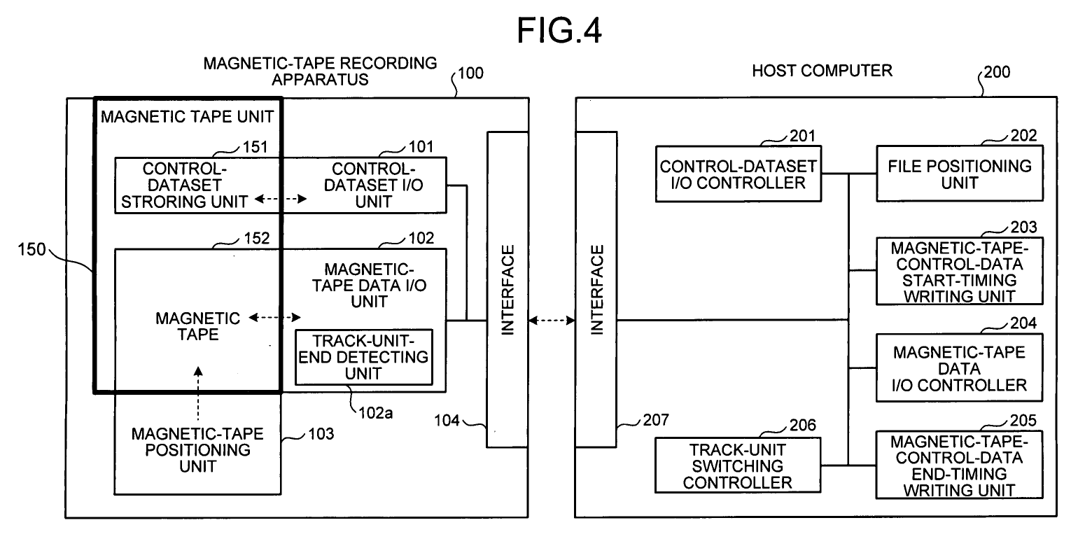

FIG. 4 is a block diagram of a magnetic-tape recording apparatus 100 according to the present embodiment.

A magnetic tape unit 150 that includes the magnetic tape stored in a detachable cartridge is mounted on the magnetic-tape recording apparatus 100. The magnetic tape unit 150 includes a control-dataset storing unit 151 in the form of a semiconductor memory and a magnetic tape.152. The control-dataset storing unit 151 stores therein the control dataset shown in FIG. 2 and FIG. 3.

The magnetic-tape recording apparatus 100 includes, as a functional structure of the magnetic-tape recording apparatus 100, a control-dataset input/output (I/O) unit 101, a magnetic-tape data I/O unit 102, a magnetic-tape positioning unit 103, and an interface 104 that controls communication with a host computer 200. The magnetic-tape data I/O unit 102 further includes a track-unit-end detecting unit 102a.

The control-dataset I/O unit 101 exchanges data of the control dataset between the magnetic-tape recording apparatus 100 and the control-dataset storing unit 151 of the magnetic tape unit 150. In other words, the control-dataset I/O unit 101 reads from the control-dataset storing unit 151 a track unit number, file data (file name, number of records, and file end position), and a linked track-unit number and transmits the read data to the host computer 200 via the interface 104. Based on an instruction from the host computer 200, the control-dataset I/O unit 101 newly adds or updates data of the control dataset.

The magnetic-tape data I/O unit 102 includes a read/write magnetic head. Based on the instruction from the host computer 200, the magnetic-tape data I/O unit 102 writes data to the magnetic tape 152 or reads data from the magnetic tape 152. During reading or writing of data, the track-unit-end detecting unit 102a included in the magnetic-tape data I/O unit 102 detects the end of a track cluster.

The magnetic-tape positioning unit 103 exercises control by controlling rotation of reels that wind the magnetic tape 152 such that the read write magnetic head of the magnetic-tape data I/O unit 102 is positioned at a specified tape position of the magnetic tape 152.

The host computer 200 includes a control-dataset I/O controller 201, a file positioning unit 202, a magnetic-tape-control-data start-timing writing unit 203, a magnetic-tape data I/O controller 204, a magnetic-tape-control-data end-timing writing unit 205, a track-unit switching controller 206, and an interface 207 that controls communication with the magnetic-tape recording apparatus 100. Although the host computer 200 also includes functions of a computer, only the functional blocks related to the present embodiment are shown in FIG. 4, and the functional blocks related to the functions of the computer are omitted.

The control-dataset I/O controller 201 controls the control-dataset I/O unit 101 to carry out reading, writing, or updation of the control dataset that is stored in the control-dataset storing unit 151 inside the magnetic tape unit 150.

Based on a file specification, the file positioning unit 202 controls the magnetic-tape positioning unit 103, searches the specified file, and carries out a process to position the read/write magnetic head of the magnetic-tape data I/O unit 102 at a process starting position of the magnetic tape 152.

When outputting (recording) data to the magnetic tape 152, before the output of the data, the magnetic-tape-control-data start-timing writing unit 203 controls the control-dataset I/O unit 101, thereby causing control data of the data for recording to be stored in the control-dataset storing unit 151. The magnetic-tape-control-data start-timing writing unit 203 controls the magnetic-tape data I/O unit 102, thereby causing header label data to be recorded in the magnetic tape 152.

When ending output (recording) of data to the magnetic tape 152, immediately after ending the output, the magnetic-tape data I/O controller 204 controls the control-dataset I/O unit 101, thereby causing the control data of the data for recording to be stored in the control-dataset storing unit 151. The magnetic-tape data I/O controller 204 controls the magnetic-tape data I/O unit 102, thereby causing the header label data to be recorded in the magnetic tape 152.

During writing of data to the magnetic tape 152 or reading of data from the magnetic tape 152, if the read/write magnetic head of the magnetic-tape data I/O unit 102 has reached the end of the track unit that is currently in process, the track-unit switching controller 206 controls the magnetic-tape data I/O unit 102 and carries out a process to position the read/write magnetic head at the track unit that is subsequently subjected to the reading process or the writing process.

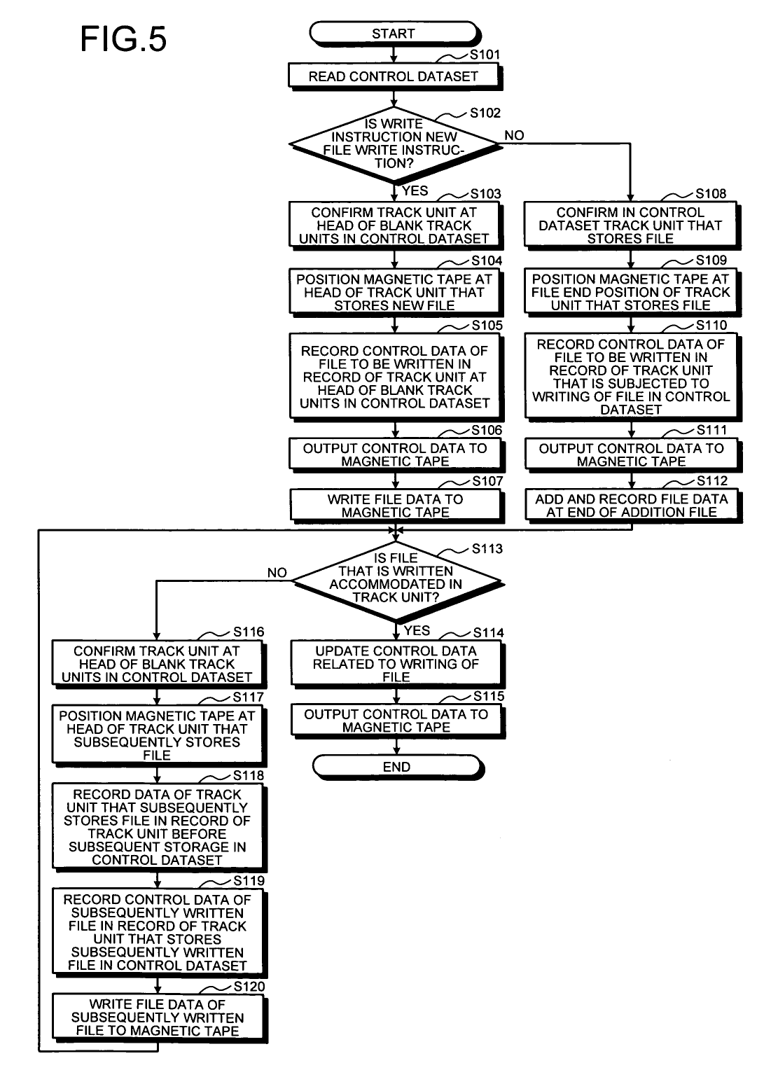

FIG. 5 is a flowchart of a sequence of the magnetic-tape recording process executed by the magnetic-tape recording apparatus 100 and the host computer 200.

The magnetic-tape recording apparatus 100 reads the control dataset (step S101). The magnetic-tape recording apparatus determines whether a write instruction of the file is a new file write instruction (step S102). If the write instruction is a new file write instruction (“Yes” at step S102), the magnetic-tape recording process moves to step S103. If the write instruction is not a new file write instruction, in other words, if the write instruction is an add update instruction of data of an already existing file (“No” at step S102), the magnetic-tape recording process moves to step S108.

The magnetic-tape recording apparatus 100 confirms a track unit at the head of the blank track units in the control dataset (in other words, a track unit having the lowest track unit number among the track units that do not include a recorded file) at step S103, and positions the magnetic tape 152 at the physical head of the track unit that stores therein the new file (step S104).

The magnetic-tape recording apparatus 100 stores control data of the file to be written in the record of the track unit at the head of the blank track units (in other words, the track unit having the lowest track unit number among the track units that do not include a recorded file) in the control dataset that is stored in the control-dataset storing unit 151 (step S105).

The magnetic-tape recording apparatus 100 outputs (records) to the magnetic tape 152, control data such as the header label data before writing of file data (step S106). Next, the magnetic-tape recording apparatus 100 writes data of the new file to the magnetic tape 152 (step S107). Upon completion of step S107, the magnetic-tape recording process moves to step S113.

The magnetic-tape recording apparatus 100 confirms at step S108 the track unit that stores therein the file that is subjected to addition and updation of data, and positions the magnetic tape 152 at the file end position (in other words, the end of the file) of the track unit that stores therein the file (step S109).

The magnetic-tape recording apparatus 100 stores in the control dataset that is stored in the control-dataset storing unit 151, the control data of the file to be written in the record of the track unit that stores therein the file that is subjected to writing of data (step S110).

The magnetic-tape recording apparatus 100 outputs (records) to the magnetic tape 152, control data such as the header label data before writing of file data (step Sill). The magnetic-tape recording apparatus 100 adds and records file data at the end of the addition file in the magnetic tape 152 (step S112). Upon completion of step S112, the magnetic-tape recording process moves to step S113.

The magnetic-tape recording apparatus 100 determines at step 113 whether writing of the file is accommodated in the track unit, in other words, the magnetic-tape recording apparatus 100 determines whether the end of the track unit is detected during writing of the file by the track-unit-end detecting unit 102a.

If the end of the track unit is not detected by the track-unit-end detecting unit 102a, in other words, if the file that is written is accommodated in the track unit (“Yes” at step S113), the magnetic-tape recording apparatus 100 updates the control data related to writing of the file that is stored in the control-dataset storing unit 151 (step S114), and outputs (records) to the magnetic tape 152 control data such as the header label data after writing of file data (step S115).

If the end of the track unit is detected by the track-unit-end detecting unit 102a, in other words, if the file that is written is not accommodated in the track unit (“No” at step S113), the magnetic-tape recording apparatus 100 confirms a track unit at the head of the blank track units that are stored in the control-dataset storing unit 151 (in other words, a track unit having the lowest track unit number among the track units that do not include a recorded file) (step S116).

The magnetic-tape recording apparatus 100 positions the magnetic tape 152 at the physical head of the track unit that subsequently stores the file (step S117), and stores data (in other words, the linked track-unit number) of the track unit that includes the subsequently written file in the record of the track unit before continuation in the control dataset (step S118).

The magnetic-tape recording apparatus 100 stores in the control dataset that is stored in the control-dataset storing unit 151, the control data of the subsequently written file in the record of the track unit that includes the subsequently written file (step S119). Next, the magnetic-tape recording apparatus 100 writes data of the subsequently written file to the magnetic tape 152 (step S120). Upon completion of the aforementioned process, the magnetic-tape recording process moves to step S113.

According to the present embodiment, because each file is recorded in a track unit, saved status of other files is not affected even after carrying out addition of file data. Further, a head of the file always matches with a head of the track unit, thereby enabling to significantly reduce the time required to access the file.

The efficiency of file access in the aforementioned embodiment is superior in comparison with a process that carries out file control by allocating an index to each file. The process to search the index and to position the read/write magnetic head of the magnetic tape at the index position requires comparatively longer time period. However, in the aforementioned embodiment, because the head of the file always matches with the head of the track unit and the head of the track unit is the physical head of the magnetic tape, the processing time that is required in the process to position the read/write magnetic head at the head of the file is comparatively short.

Although the invention has been described with respect to a specific embodiment for a complete and clear disclosure, the present invention is not to be thus limited, and various modifications may be made without departing from the spirit or scope of the general inventive concept as defined by the appended claims and their equivalents. The effect described in the present embodiment is not to be thus limited. A track unit that includes two adjacent tracks is explained as an example of a track unit in the present embodiment. However, other combinations of tracks can also be used.

According to an embodiment of the present invention, multiple tracks on a magnetic tape are allocated track-unit identification data as a single track unit, a single file is allocated and recorded in the track unit, and control dataset of the file is related with the track-unit identification data and stored. When recording multiple files in the magnetic tape, the required file is searched from the memory, thereby enabling to speedily access the file and enabling, in a comparatively short time, to position the magnetic tape in a position that enables reading and writing.

Furthermore, according to an embodiment of the present invention, among the track-unit identification data that are still not related with the control dataset of the files and stored, the uppermost ordered track unit is detected, and the specified file is recorded in the detected track unit. Thus, when newly recording a file, the file can be recorded in the track unit that is specified according to a sequence of the track-unit identification data, thus enabling to prevent disordered positioning of the files in the track units and enabling to prevent reduction in the process efficiency of file access.

Moreover, according to an embodiment of the present invention, among the track-unit identification data that are still not related with the control dataset of the files and stored, the uppermost ordered track unit is detected, and the specified file is recorded in the detected unit. Thus, a file, which includes data that cannot be completely recorded in a single track unit, can be recorded by extending the file to multiple track units.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of setting a plurality of tracks as a track unit on a magnetic tape, allocating track-unit identification data to the track unit, and performing a round-trip recording of a single file on the tracks forming the track unit, the method comprising:
storing a control dataset of a file to be recorded on a track unit that is identified by the track-unit identification data, in association with the track-unit identification data;
specifying a track unit for recording a specified file, based on the stored control dataset; and
recording the specified file on the specified track unit.

2. The method according to claim 1, further comprising:
determining, when the track unit for recording the specified file cannot be specified, a first track-unit being next in line from among track units for which the control dataset is not stored in association with the track-unit identification data, wherein
the recording includes recording the specified file on the first track-unit.

3. The method according to claim 1, further comprising:
detecting whether a data size of the specified file exceeds a data size of the specified track unit; and
determining, when it is detected that the data size of the specified file exceeds the data size of the specified track unit, a track unit being next in line from among track units for which the control dataset is not stored in association with the track-unit identification data, wherein
the recording includes recording in succession the specified file on the determined track unit.

4. The method according to claim 2, further comprising:
detecting whether a data size of the specified file exceeds a data size of the first track-unit, wherein
the determining includes determining, when it is detected that the data size of the specified file exceeds the data size of the first track-unit, a second track-unit being next in line from among track units for which the control dataset is not stored in association with the track-unit identification data, and
the recording includes recording in succession the specified file on the second track-unit.

5. The method according to claim 3, wherein the storing includes storing the determined track unit in the control dataset as a linked track-unit.

6. The method according to claim 4, wherein
the storing includes storing the second track-unit in the control dataset as a linked track-unit.

7. The method according to claim 1, wherein
the tracks forming the track unit are two adjacent tracks.

8. A magnetic-tape recording apparatus that records a file on a magnetic tape based on a file recording instruction from a computer to which the magnetic-tape recording apparatus is connected, the magnetic-tape recording apparatus setting a plurality of tracks as a track unit on the magnetic tape, allocating track-unit identification data to the track unit, and performing a round-trip recording of a single file on the tracks forming the track unit, the magnetic-tape recording apparatus comprising:
a control-dataset input/output unit that performs input and output of the track-unit identification data and a control dataset of the file corresponding to the track-unit identification data, in response to an instruction from the computer;
a position determining unit that determines a recording position of the file on the magnetic tape based on the track-unit identification data and the control dataset; and
a file-data input/output unit that reads or records data of the file at the recording position determined by the position determining unit.

9. The magnetic-tape recording apparatus according to claim 8, wherein
the file-data input/output unit includes a track-unit-end detecting unit that detects an end of the track unit.

10. The magnetic-tape recording apparatus according to claim 8, wherein
the tracks forming the track unit are two adjacent tracks.

11. A magnetic tape unit for setting a plurality of tracks as a track unit on a magnetic tape, allocating track-unit identification data to the track unit, and performing a round-trip recording of a single file on the tracks forming the track unit, the magnetic tape unit comprising:
a control-dataset storing unit that stores a control dataset of a file to be recorded on a track unit that is identified by the track-unit identification data, in association with the track-unit identification data.

12. The magnetic tape unit according to claim 11, wherein
the tracks forming the track unit are two adjacent tracks.

13. A computer system configured to be connected to a magnetic-tape recording apparatus that sets a plurality of tracks as a track unit on a magnetic tape, allocates track-unit identification data to the track unit, and performs a round-trip recording of a single file on the tracks forming the track unit, the magnetic tape being installed in a magnetic tape unit including a control-dataset storing unit, the computer system comprising:
a control-dataset storage controller that controls storing a control dataset of a file to be recorded on a track unit that is identified by the track-unit identification data, in association with the track-unit identification data, in the control-dataset storing unit;
a track-unit specification controller that controls specifying a track unit for recording a specified file, based on the stored control dataset; and
a file recording controller that controls recording the specified file on the specified track unit.

14. The computer system according to claim 13, further comprising:
a track-unit determination controller that controls determining, when the track unit for recording the specified file cannot be specified, a first track-unit being next in line from among track units for which the control dataset is not stored in association with the track-unit identification data, wherein
the file recording controller records the specified file on the first track-unit.

15. The computer system according to claim 13, further comprising:
a data-size detecting unit that detects whether a data size of the specified file exceeds a data size of the specified track unit; and
a track-unit determination controller that controls determining, when it is detected that the data size of the specified file exceeds the data size of the specified track unit, a track unit being next in line from among track units for which the control dataset is not stored in association with the track-unit identification data, wherein
the file recording controller records in succession the specified file on the determined track unit.

16. The computer system according to claim 14, further comprising:
a data-size detecting unit that detects whether a data size of the specified file exceeds a data size of the first track-unit, wherein
the track-unit determination controller determines, when it is detected that the data size of the specified file exceeds the data size of the first track-unit, a second track-unit being next in line from among track units for which the control dataset is not stored in association with the track-unit identification data, and
the file recording controller records in succession the specified file on the second track-unit.

17. The computer system according to claim 15, wherein
the control-dataset storage controller stores the determined track unit in the control dataset as a linked track-unit.

18. The computer system according to claim 16, wherein
the control-dataset storage controller stores the second track-unit in the control dataset as a linked track-unit.

19. The computer system according to claim 13, wherein
the tracks forming the track unit are two adjacent tracks.
